(19) United States
(12) Patent Application Publication
(10) Pub. No.: US 2014/0028812 A1
(43) Pub. Date: Jan. 30, 2014

(54) THREE-DIMENSIONAL VIDEO DISPLAY APPARATUS

(71) Applicant: KABUSHIKI KAISHA TOSHIBA, Tokyo (JP)

(72) Inventor: Tatsuo Saishu, Tokyo (JP)

(73) Assignee: KABUSHIKI KAISHA TOSHIBA, Tokyo (JP)

(21) Appl. No.: 13/794,122

(22) Filed: Mar. 11, 2013

(30) Foreign Application Priority Data
Jul. 27, 2012 (JP) 2012-166874

(51) Int. Cl. H04N 13/04

(52) U.S. Cl. CPC H04N 13/0409
USPC 348/54

(57) ABSTRACT

A three-dimensional video display apparatus according to an embodiment includes: a display panel comprising pixels in a matrix form along a first direction and a second direction perpendicular to the first direction; an optical plate having a plurality of optical apertures in the first direction and extending in a straight line form with inclination from the second direction, the inclination of the optical apertures being changeable; a detection unit detecting a face and eyes of a viewer; an angle calculation unit calculating an inclination angle of a straight line coupling the detected eyes from the first direction; a control unit controlling the optical plate to change over the inclination of the optical apertures when the inclination angle is greater than a threshold; and a pixel mapping generation unit changing mapping of the pixels in response to the changeover in the optical plate.

### CROSS-REFERENCE TO RELATED APPLICATION

This application is based upon and claims the benefit of priority from prior Japanese Patent Application No. 2012-166874 filed on Jul. 27, 2012 in Japan, the entire contents of which are incorporated herein by reference.

### FIELD

Embodiments described herein relate generally to a three-dimensional video display apparatus.

### BACKGROUND

In general, a glasses-free three-dimensional video display apparatus which does not need glasses for a stereoscopic view includes a display panel having a display face formed of pixels arranged in a matrix form, and an optical plate having optical apertures provided in front of or behind the display panel to control light rays from the pixels of the display panel and provide a parallax in one direction (for example, the horizontal direction or a direction inclined from the horizontal direction by a predetermined angle).

In such a three-dimensional video display apparatus, normal stereoscopic viewing is possible if a head of a viewer is positioned to have a straight line coupling centers of eyes of the viewer in the horizontal direction or in a direction inclined slightly from the horizontal direction.

If the straight line coupling centers of eyes of the viewer is inclined considerably from the horizontal direction, for example, if the viewer views while lying in front of a large screen, however, the viewer eventually views a two-dimensional video and normal stereoscopic viewing becomes impossible.

Furthermore, a viewing zone where normal stereoscopic viewing is possible without causing a pseudoscopic state is narrow, therefore it is conducted to detect the eye position of the viewer and display an interleaved stereoscopic video according to the viewing position of the viewer.

In the case where the straight line coupling centers of eyes of the viewer inclines considerably from the horizontal direction, for example, in the case where the viewer views while lying, however, normal stereoscopic viewing is impossible.

As for portable devices used with the screen turned in one of longitudinal and lateral directions, portable devices in which a barrier for stereoscopic view can be changed over between a longitudinal disposition and a lateral disposition according to a changeover between a longitudinal disposition and a lateral disposition are known.

However, the changeover is restricted to a changeover in two stages, i.e., longitudinal and lateral stages, utilizing direction detection using a gyro sensor. Glasses-free portable devices are restricted to binocular devices which are suitable for only a small-sized screen.

### BRIEF DESCRIPTION OF THE DRAWINGS

FIG. 1 is a block diagram showing a three-dimensional video display apparatus according to a first embodiment;

FIG. 2 is a diagram for explaining an example of an active optical plate;

FIGS. 3(a) to 3(c) are diagrams for explaining an inclination of a viewer's face;

FIG. 4 is a block diagram showing a three-dimensional video display apparatus according to a second embodiment;

FIGS. 5(a) to 5(d) are diagrams for explaining pixel mapping;

FIGS. 6(a) and 6(b) are diagrams for explaining an effect of the second embodiment;

FIG. 7 is a block diagram showing a three-dimensional video display apparatus according to a third embodiment;

FIG. 8 is a block diagram showing a three-dimensional video display apparatus according to a fourth embodiment;

FIGS. 9(a) to 9(c) are diagrams for explaining correction of a parallax direction of a parallax image in the fourth embodiment; and

FIGS. 10(a) and 10(b) are diagrams for explaining selection of an oblique lens in the case where there are a plurality of viewers.

### DETAILED DESCRIPTION

A three-dimensional video display apparatus according to an embodiment includes: a display panel comprising pixels in a matrix form along a first direction and a second direction perpendicular to the first direction; an optical plate opposing the display panel, the optical plate having a plurality of optical apertures in the first direction, the plurality of optical apertures extending in a straight line form with inclination from the second direction, the inclination of the optical apertures being able to be changed in a plurality of ways; a detection unit configured to detect a face and eyes of a viewer; an angle calculation unit configured to calculate an inclination angle of a straight line coupling the detected eyes from the first direction; a control unit configured to control the optical plate to change over the inclination of the optical apertures when the inclination angle is greater than a threshold; and a pixel mapping generation unit configured to change mapping of the pixels in response to the changeover in the optical plate.

Hereafter, embodiments will be described more in detail with reference to the accompanying drawings.

### First Embodiment

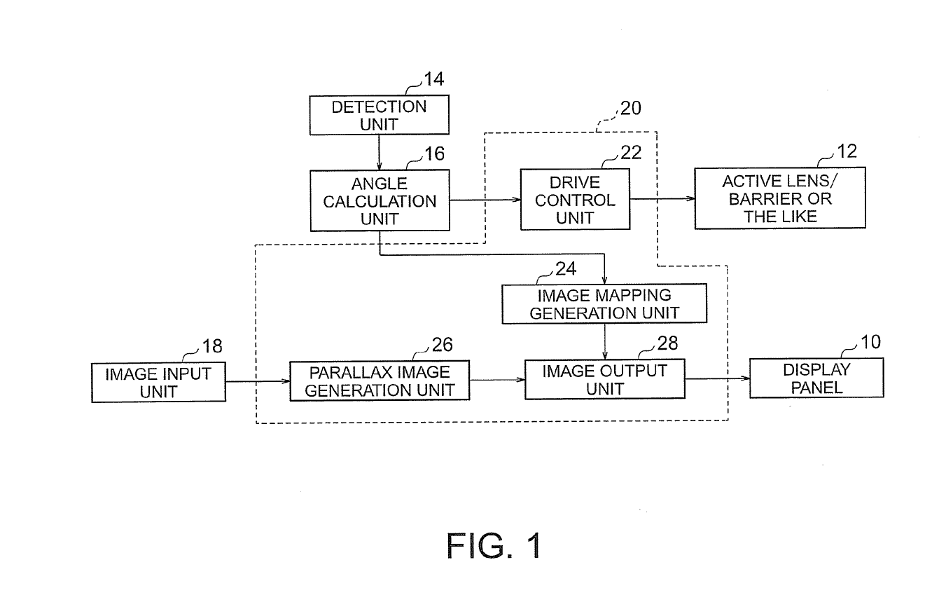

A three-dimensional video display apparatus according to a first embodiment is shown in FIG. 1. The three-dimensional video display apparatus according to the first embodiment is a glasses-free three-dimensional video display apparatus which does not need glasses for stereoscopic view. The three-dimensional video display apparatus according to the first embodiment includes a display panel 10 having a display face formed of pixels arranged in a matrix form (along the horizontal direction and the vertical direction), an optical plate 12 having optical apertures provided in front of or behind the display panel 10 to provide a parallax in one direction, a detection unit 14 which detects positions of a face and eyes of a viewer, an angle calculation unit 16 which calculates an inclination angle of the viewer's face, an image input unit 18 which receives an image signal from external, and a control unit 20.

As for the display panel 10, a liquid crystal display panel, a plasma display panel, an organic EL panel, or the like can be used. The optical plate 12 is an active optical plate in which optical apertures providing a parallax are arranged in the horizontal direction of the display panel 10. The active optical plate has a function capable of changing over an extension direction of the optical apertures (a direction in which the parallax is provided) between at least two angles inclined from the vertical direction of the display panel 10. As this active optical plate, an active lens, a GRIN (gradient index) lens, an active barrier, a pattern diffuser backlight, a line source array, and the like can be mentioned.

The detection unit 14 detects the positions of the face and eyes of the viewer. As the detection unit 14, a camera or the like is used. The detection unit 14 is provided on, for example, a frame of the display panel 10.

The angle calculation unit 16 calculates an inclination angle of a straight line coupling centers of eyes of a viewer from the horizontal direction on the basis of positions of the eyes of the viewer detected by the detection unit 14. If the calculated angle exceeds a predetermined threshold (for example, a value in the range of +30° to +45° and the range of −30° to −45°), then the angle calculation unit 16 determines a modified angle value at which the viewer can conduct normal stereoscopic viewing. In the first embodiment, the modified angle value is a modified inclination angle of a parallax direction of the optical plate 12, i.e., an arrangement direction of the optical apertures from the vertical direction of the display panel 10.

The control unit 20 includes a drive control unit 22 which drives and controls the optical plate 12, a pixel mapping generation unit 24, a multiple parallax image generation unit 26 which generates a multiple parallax image from an image which is input to the image input unit 18, and an image output unit 28. The drive control unit 22 exercises drive control to cause a parallax direction of the optical plate 12 to assume the modified angle value on the basis of the modified angle value determined by the angle calculation unit 16. The pixel mapping generation unit 24 conducts angle correction on pixel mapping on the basis of the modified angel value calculated by the angle calculation unit 16. If the image which is input to the image input unit 18 is a two-dimensional image, then the multiple parallax image generation unit 26 detects depth information from the two-dimensional image, and generates a multiple parallax image required to display a three-dimensional image from the two-dimensional image using the depth information. If the image which is input to the image input unit 18 is a multiple parallax image for displaying a three-dimensional image, then the multiple parallax image generation unit 26 converts the multiple parallax image to a multiple parallax image suitable for display on the display panel 10.

The image output unit 28 converts the multiple parallax image generated by the multiple parallax image generation unit 26 to an image suitable for display on the display panel 10, i.e., an image form having elemental images arranged to correspond to respective optical apertures of the optical plate, according to pixel mapping generated by the pixel mapping generation unit 24. The image output unit 28 sends a resultant image to the display panel 10 and causes the display panel 10 to display the image.

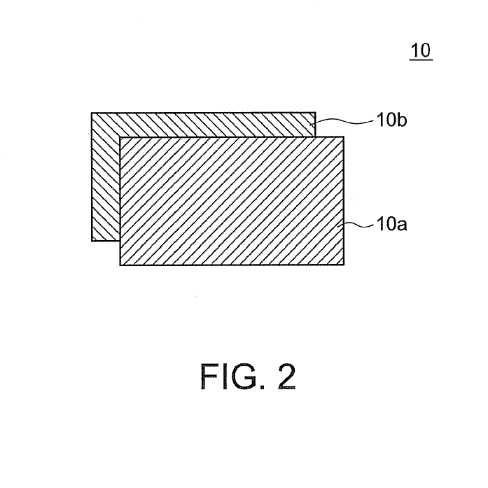

An example of the active optical plate 10 will now be described with reference to FIG. 2. In the case of the active lens or the active barrier, a structure having a liquid crystal layer between two glass substrates 10a and 10b is typical. Thin electrodes extending in the same direction as the extension direction of the optical apertures are formed on each glass substrate at the same periods as periods in the arrangement of the optical apertures. Electrodes are provided at a rate of one or more per optical aperture. Only transparent electrodes are used, or in some cases auxiliary metallic electrodes are used together. An angle of the optical apertures can be changed over by, for example, using a configuration in which the substrates 10a and 10b differ in electrode direction. In this case, one out of angles of two kinds, for example, one of rightward rising and leftward rising with respect to the horizontal direction can be selected by applying a constant common voltage to the whole of the electrodes on one substrate and supplying a drive voltage to the electrodes on the other substrate. In the case of the GRIN lens, a structure having fine electrodes spread all over the both substrates may be used. The fine electrodes may have a two-layer structure as occasion demands. In the case of the active barrier, electrodes equivalent to apertures or shading parts should be provided on both substrates. As occasion demands, an electrode structure in which the face is filled with a two-layer structure may be used. Furthermore, it is also possible that one glass substrate is a plane electrode having no divisions and the other glass substrate has a configuration in which active lenses or active barriers divided as described above corresponding to only optical apertures in one direction are piled up in a multi-layer form. Besides, a pattern diffuser back light or a line source array may also be used as long as changeover between angles of at least two kinds is possible. As for the angle of the optical plate 12, many optical plates having an angle in the range of approximately 10° to 15° are known. For conducting the angle correction as in the present embodiment, however, an angle which is large to some degree is desirable. Furthermore, it is desirable that the active optical plate 12 can also be changed over to a two-dimensional image, i.e., a state in which the effect of giving parallax is turned off.

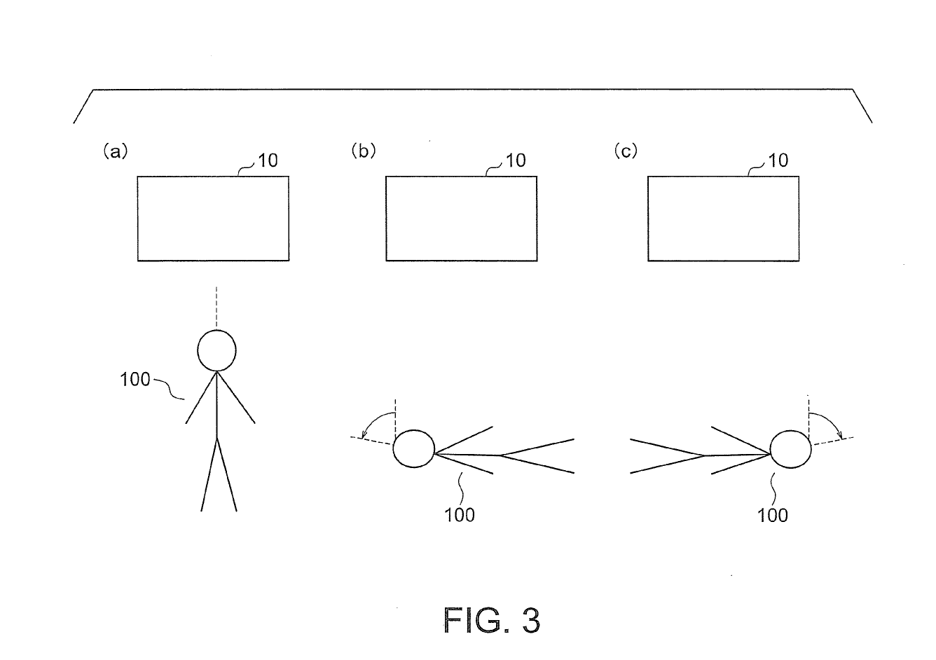

FIGS. 3(a) to 3(c) are diagrams for explaining inclination of a face of a viewer 100. FIG. 3(a) shows a case where the face of the viewer 100 is normal with respect to the display panel 10, i.e., a case where a straight line coupling eyes of the viewer 100 is perpendicular to a vertical direction of the display panel 10. FIGS. 3(b) and 3(c) show cases where the face of the viewer 100 inclines largely. FIG. 3(b) shows a case where the face inclines in a positive direction (counterclockwise direction). FIG. 3(c) shows a case where the face inclines in a negative direction (clockwise direction). In the case where the face inclination is large as in FIGS. 3(b) and 3(c), it is effective to conduct correction of the present embodiment. Depending upon whether the angle is in the positive direction or in the negative direction, different correction is conducted. If the face inclines in the positive direction in excess of a threshold, then the inclination of the optical plate is changed over to a direction of leftward rising. If the face inclines in the negative direction in excess of a threshold, then the inclination of the optical plate is changed over to a direction of rightward rising. At the same time, the pixel mapping is also changed over to pixel mapping conforming to the inclination of the optical plate. In a case of a configuration in which changeover to multiple stages is possible as well, the pixel mapping is changed over to pixel mapping conforming to the inclination of the optical plate in the same way.

Even if the angle of the viewer's face changes with respect to the display panel 10, the inclination angle of the face is detected and if the detected inclination angle exceeds a predetermined threshold, the parallax direction of the active optical plate 12 is changed, according to the present embodiment as described heretofore. As a result, the image can be displayed to cause the viewer to be able to conduct normal stereoscopic viewing. Even in a state in which the viewer is lying, therefore, stereoscopic viewing becomes possible. By the way, if a two-dimensional lens array or a two-dimensional pinhole array is used instead of the optical plate in the present embodiment, the stereoscopic viewing is possible regardless of the angle of the viewer's face without conducting angle changeover as in the present embodiment. In this case, however, there is a problem of a lowered resolution. According to the configuration in the present embodiment, stereoscopic viewing becomes possible regardless of the angle of the viewer's face without lowering the resolution.

### Second Embodiment

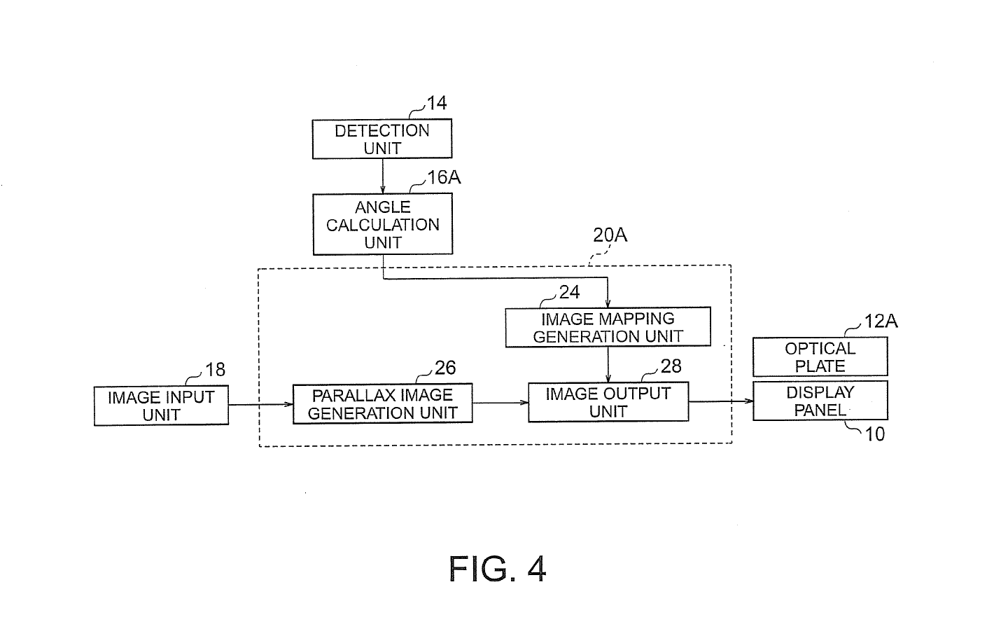

A three-dimensional video display apparatus according to a second embodiment is shown in FIG. 4. The three-dimensional video display apparatus according to the second embodiment has a configuration obtained by replacing the optical plate 12, the angle calculation unit 16 and the control unit 20 in the three-dimensional video display apparatus according to the first embodiment shown in FIG. 1 with an optical plate 12A, an angle calculation unit 16A and a control unit 20A, respectively.

The optical plate 12A has optical apertures which provide a parallax in one direction. Unlike the optical plate 12, however, the extension direction of the optical apertures (the direction in which the parallax is provided) cannot be changed.

The angle calculation unit 16A calculates an inclination angle of a straight line coupling centers of the eyes of the viewer from the horizontal direction on the basis of the positions of the eyes of the viewer detected by the detection unit 14. If the calculated angle exceeds a predetermined threshold (for example, a value in the range of +30° to +45° and the range of −30° to −45°), the angle calculation unit 16A determines a modified angle value at which the viewer can conduct normal stereoscopic viewing. In the second embodiment, the modified angle value is a modified inclination angle for shifting pixel mapping with respect to the inclination angle of the parallax direction of the optical plate 12.

The control unit 20A has a configuration obtained by removing the drive control unit 22 in the control unit 20 shown in FIG. 1. The pixel mapping generation unit 24 conducts angle correction of the pixel mapping on the basis of the modified angle value calculated by the angle calculation unit 16A. A parallax image generated by the parallax image generation unit 26 is converted to an output image in the image output unit 28 by using pixel mapping generated by the pixel mapping generation unit 24. The output image is displayed on the display panel 10.

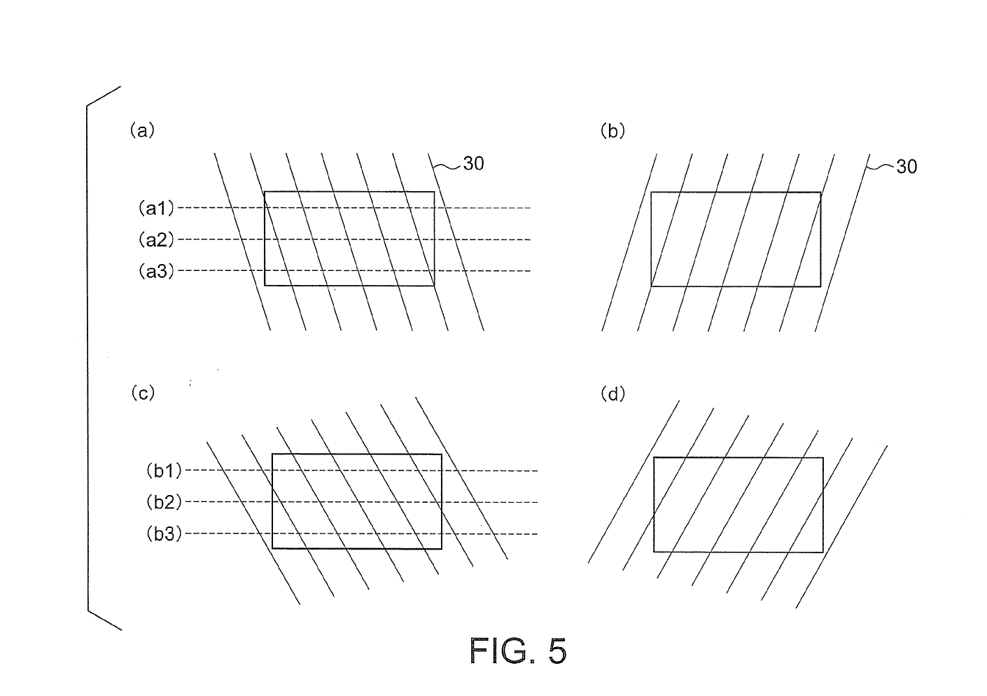

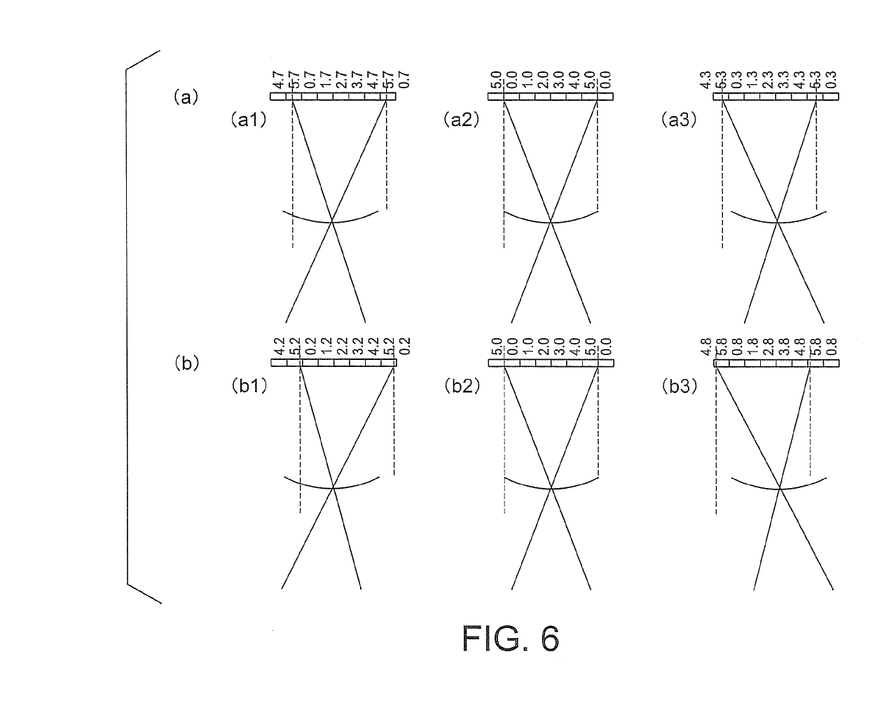

FIGS. 5(a) to 5(d) are diagrams showing a parallax direction (division direction of a viewing zone area) in the case where the screen is viewed from the viewer side. FIGS. 5(a) to 5(d) show that parallax images in different directions are seen in a direction crossing oblique lines, i.e., there is a motion parallax. Usually, as shown in FIG. 5(a) or FIG. 5(b), a parallax direction (division direction of the viewing zone area) is taken in an arrangement direction of the optical apertures (for example, lenses) of the optical plate. FIG. 5(a) shows a case where the extending direction of the optical apertures of the optical plate inclines in a direction 30 from upper left toward lower right and the arrangement direction of the optical apertures of the optical plate is perpendicular to the direction of the line 30. FIG. 5(b) shows a case where the extending direction of the optical apertures of the optical plate inclines in a direction from upper right toward lower left and the arrangement direction of the optical apertures of the optical plate is perpendicular to the direction of the line 30. In the case where the face inclines as shown in FIGS. 3(b) and 3(c), however, the division direction of the viewing zone area are corrected as shown in FIGS. 5(c) and 5(d), respectively. This is conducted by angle correction of the pixel mapping, i.e., by shifting the angle of the pixel mapping slightly from the angle of the optical apertures of the optical plate 12, i.e., the inclination angle of the direction 30. For example, it is supposed that pixel mapping in positions (a1), (a2) and (a3) shown in FIG. 5(a) is changed to pixel mapping in positions (b1), (b2) and (b3) shown in FIG. 5(c) by the pixel mapping generation unit 24. In this case, pixel mapping in the positions (a1), (a2) and (a3) shown in FIG. 5(a) become (a1), (a2) and (a3) shown in FIG. 6(a), respectively. And pixel mapping in the positions (b1), (b2) and (b3) shown in FIG. 5(c) become (b1), (b2) and (b3) shown in FIG. 6(b), respectively. As appreciated from FIGS. 6(a) and 6(b), physical position relations between the optical apertures (for example, lenses) of the optical plate and pixels do not change between FIGS. 6(a) and 6(b). However, deviations of pixel areas assigned to the optical apertures (for example, in the case of six parallaxes, in a range of parallax number 5.5 to 0.0 . . . to 5.5) become greater in FIG. 6(b), and deviations of the viewing zone from the up-down direction of the display screen of the display panel becomes great.

Therefore, the angle of the viewing zone area (the distribution angle of the viewing zone) becomes great. In the case where the face inclination is great, the angle of the viewing zone area can be made close to the face inclination. Since the parallax direction changes depending upon the viewing distance as well, it is desirable to detect the face position (in the viewing distance direction) as well simultaneously with the face angle detection, and conduct correction. By the way, in the case of the extending direction 30 of the optical apertures (for example, lenses) of the optical plate as shown in FIG. 5(b), it is changed as shown in FIG. 5(d) by the pixel mapping generation unit 24.

According to the second embodiment, the distribution angle of the viewing zone is changed by the pixel mapping generation unit 24 when the inclination angle of the viewer's face has exceeded a predetermined threshold, as described heretofore. As a result, the image can be displayed to provide the viewer with a normal stereoscopic view. Accordingly, normal stereoscopic viewing becomes possible even in a state in which the viewer is lying. Furthermore, stereoscopic viewing becomes possible regardless of the angle of the viewer's face without lowering the resolution in the same way as the case of the first embodiment.

### Third Embodiment

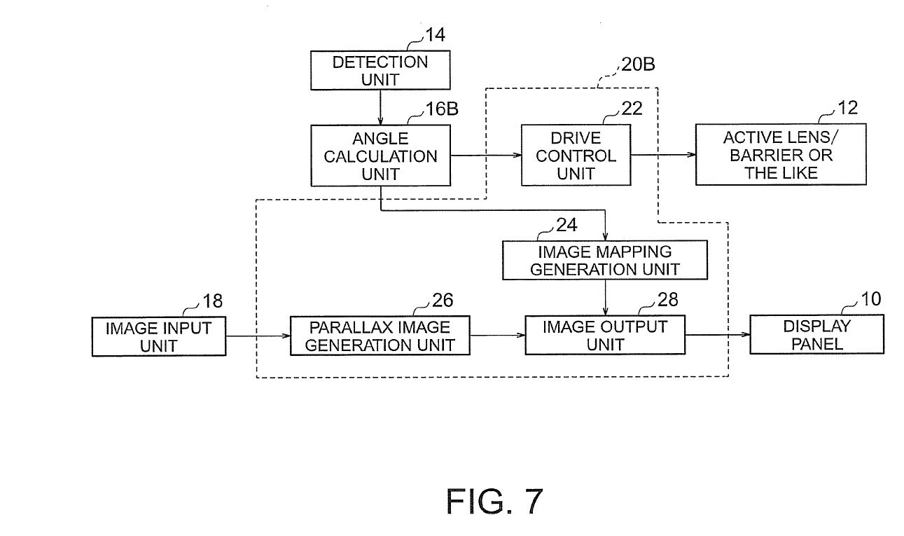

A three-dimensional video display apparatus according to a third embodiment is shown in FIG. 7. The three-dimensional video display apparatus according to the third embodiment has a configuration obtained by replacing the angle calculation unit 16 and the control unit 20 in the three-dimensional video display apparatus according to the first embodiment shown in FIG. 1 with an angle calculation unit 16B and a control unit 20B, respectively.

The control unit 20B has a configuration including the pixel mapping generation unit 24 in the same way as the control unit 20. The angle calculation unit 16B calculates the modified inclination angle of the parallax direction of the optical plate 12 from the vertical direction of the display panel 10 in the same way as the first embodiment. In addition, the angle calculation unit 16B also calculates the modified inclination angle by which the pixel mapping is shifted with respect to the inclination angle of the parallax direction of the optical plate 12 in the same way as the second embodiment.

Therefore, the third embodiment has a configuration in which the parallax direction of the optical plate 12 is changed over in the same way as the first embodiment and the distribution angle of the viewing zone is also changed over in the same way as the second embodiment. The pixel mapping may be changed without changing over the optical plate, when the inclination angle has exceeded a threshold which is further greater than the threshold at which the optical plate is changed over.

For example, a configuration in which the changeover of the parallax direction of the optical plate is conducted between two stages, i.e., leftward inclined and rightward inclined and the changeover of the distribution angle of the viewing zone using pixel mapping is conducted more finely in multiple stages is effective.

In the third embodiment as well, the image can be displayed to make it possible for the viewer to conduct normal stereoscopic viewing even in a state in which the viewer's face is inclined, in the same way as the first and second embodiments. Even in a state in which the viewer is lying, therefore, normal stereoscopic viewing becomes possible. Furthermore, stereoscopic viewing becomes possible regardless of the angle of the viewer's face without lowering the resolution.

### Fourth Embodiment

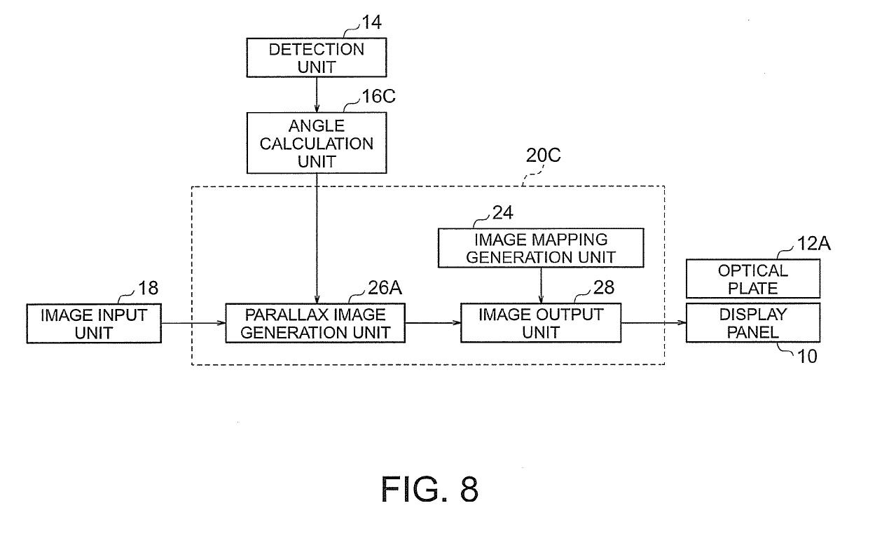

A three-dimensional video display apparatus according to a fourth embodiment is shown in FIG. 8. The three-dimensional video display apparatus according to the fourth embodiment has a configuration obtained by replacing the angle calculation unit 16A and the control unit 20A in the three-dimensional video display apparatus according to the second embodiment shown in FIG. 4 with an angle calculation unit 16C and a control unit 20C, respectively.

The control unit 20C has a configuration obtained by removing an input from the angle calculation unit 16A to the pixel mapping generation unit 24 and replacing the parallax image generation unit 26 with a parallax image generation unit 26A in the control unit 20A. The angle calculation unit 16C calculates an inclination angle of a straight line coupling centers of eyes of the viewer from the horizontal direction on the basis of positions of the eyes of the viewer detected by the detection unit 14. If the calculated angle exceeds a predetermined threshold (for example, a value in the range of +30° to +45° and the range of −30° to −45°), the angle calculation unit 16C determines a modified angle value at which the viewer can conduct normal stereoscopic viewing. In the fourth embodiment, the modified angle value is a corrected angle in the parallax direction of the parallax image.

The parallax image generation unit 26A conducts correction of the parallax direction of each parallax image on the basis of the modified angle value calculated by the angle calculation unit 16C. Each parallax image is converted to an output image by the image output unit 28, and the output image is displayed on the display panel 10.

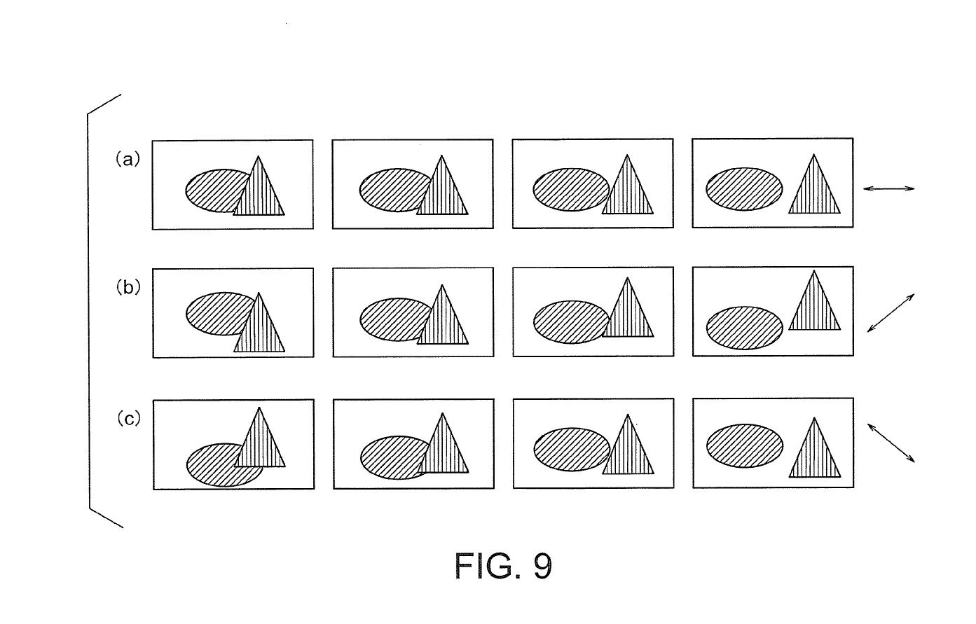

FIGS. 9(a) to 9(c) show examples of respective viewpoint images which differ in parallax direction. Each of arrows indicates a parallax direction. Parallax images shown in FIGS. 9(a) to 9(c) should be generated for the cases shown in FIGS. 3(a) to 3(c), respectively. This can be done by generating a depth map from a two-dimensional image or a three-dimensional image and generating each parallax image provided with an angle in the parallax direction according to an angle which is determined by the angle calculation unit 16C on the basis of the depth map, in the parallax image generation unit 26A.

According to the fourth embodiment, the changeover of the parallax direction of the parallax image is conducted by the parallax image generation unit 26A when the inclination angle of the viewer's face has exceeded a predetermined threshold, as described heretofore.

As a result, the image can be displayed to make it possible for the viewer to conduct normal stereoscopic viewing.

As a result, normal stereoscopic viewing becomes possible even in a state in which the viewer is lying. Furthermore, stereoscopic viewing becomes possible regardless of the angle of the viewer's face without lowering the resolution, in the same way as the first embodiment.

The changeover of the parallax direction of the parallax image in the fourth embodiment may be combined with the first to third embodiments.

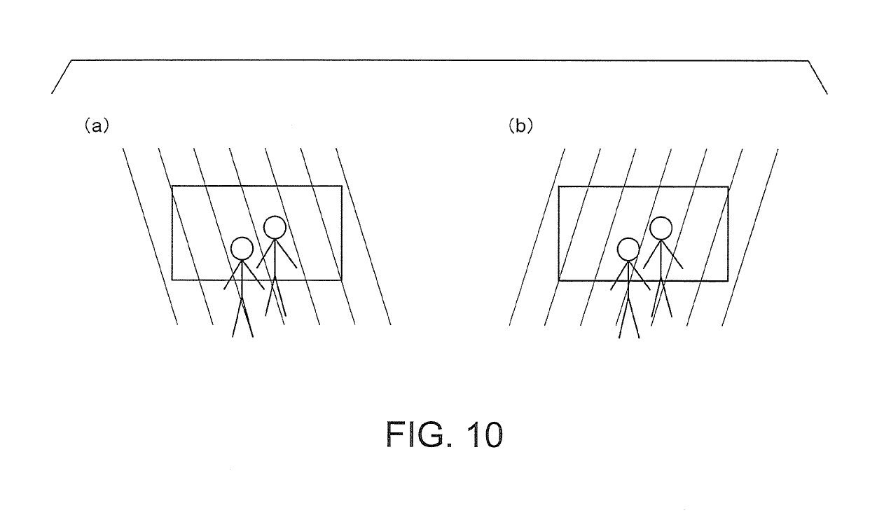

In the first to fourth embodiments, a function of selecting a conforming oblique lens when there are a plurality of viewers and a plurality of persons differ in face height may be provided. In FIGS. 10(a) and 10(b), an area between oblique lines indicates one viewing zone (lobe), i.e., an area where a series of motion parallaxes can be observed. For example, it is supposed that two persons have face heights as shown in FIGS. 10(a) and 10(b). In FIG. 10(a), each of the faces of the two persons is located in the center of the viewing zone. In FIG. 10(b), however, faces of the two persons fall onto a viewing zone boundary (an illustrated oblique line). Therefore, FIG. 10(a) is desirable.

Furthermore, a function of providing a lens inclination which produces less moiré when there is one viewer and there is no inclination (default) may also be provided. A function of selecting a lens inclination which is influenced less by external light according to the situation of the external light may also be provided.

By the way, even in a three-dimensional video display apparatus using glasses, adjustment of the parallax direction of the parallax image (each viewpoint image) is effective. If the input image is a stereo image, however, video degradation is less unless the correction is conducted, because it is restricted to a binocular use.

According to the embodiments, it is possible to provide a three-dimensional video display apparatus which makes possible normal stereoscopic viewing even in the case where the face angle of the viewer changes and it is possible to cope with the case where the viewer views while lying, as described heretofore.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A three-dimensional video display apparatus comprising:
a display panel comprising pixels in a matrix form along a first direction and a second direction perpendicular to the first direction;
an optical plate opposing the display panel, the optical plate having a plurality of optical apertures in the first direction, the plurality of optical apertures extending in a straight line form with inclination from the second direction, the inclination of the optical apertures being able to be changed in a plurality of ways;
a detection unit configured to detect a face and eyes of a viewer;
an angle calculation unit configured to calculate an inclination angle of a straight line coupling the detected eyes from the first direction;
a control unit configured to control the optical plate to change over the inclination of the optical apertures when the inclination angle is greater than a threshold; and
a pixel mapping generation unit configured to change mapping of the pixels in response to the changeover in the optical plate.

2. The three-dimensional video display apparatus of claim 1, wherein the pixel mapping generation unit changes the pixel mapping without changing over the optical plate, when the inclination angle has exceeded a second threshold which is further greater than the threshold.

3. The three-dimensional video display apparatus of claim 1, further comprising a parallax image generation unit which changes over a parallax direction of a parallax image when the inclination angle is greater than the threshold.

4. A three-dimensional video display apparatus comprising:
a display panel comprising pixels in a matrix form along a first direction and a second direction perpendicular to the first direction;
an optical plate opposing the display panel, the optical plate having a plurality of optical apertures in the first direction, the plurality of optical apertures extending in a straight line form with inclination from the second direction;
a detection unit configured to detect a face and eyes of a viewer;
an angle calculation unit configured to calculate an inclination angle of a straight line coupling the detected eyes from the first direction; and
a pixel mapping generation unit configured to change mapping of the pixels with respect to the optical plate when the inclination angle is greater than a threshold.

5. The three-dimensional video display apparatus of claim 4, further comprising a parallax image generation unit configured to change over a parallax direction of a parallax image when the inclination angle is greater than the threshold.

6. A three-dimensional video display apparatus comprising:
a display panel comprising pixels in a matrix form along a first direction and a second direction perpendicular to the first direction;
an optical plate opposing the display panel, the optical plate having a plurality of optical apertures in the first direction, the plurality of optical apertures extending in a straight line form with inclination from the second direction;
a detection unit configured to detect a face and eyes of a viewer;
an angle calculation unit configured to calculate an inclination angle of a straight line coupling the detected eyes from the first direction; and
a parallax image generation unit configured to change over a parallax direction of a parallax image when the inclination angle is greater than a threshold.
